(19) United States
(12) Patent Application Publication
(10) Pub. No.: US 2005/0288974 A1
(43) Pub. Date: Dec. 29, 2005

(54) TRAVEL SERVICE BROKER SYSTEM AND METHOD

(75) Inventors: James A. Baranowski, Scottsdale, AZ (US); Michael Keith Laughlin, Phoenix, AZ (US); Mark B. McCulloch, Highlands Ranch, CO (US); Andrew Winterton, Berks (GB)

Correspondence Address: SNELL & WILMER;ONE ARIZONA CENTER, 400 EAST VAN BUREN, PHOENIX, AZ, 850040001, US

(73) Assignee: AMERICAN EXPRESS TRAVEL RELATED SERVICES COMPANY, INC., New York, NY (US)

(21) Appl. No.: 10/908,544

(22) Filed: May 16, 2005

Related U.S. Application Data
(63) Continuation-in-part of application No. 10/708,542, filed on Mar. 10, 2004.
Application No. 10/708,542 is a continuation-in-part of application No. 10/217,666, filed on Aug. 12, 2002.
Application No. 10/708,542 is a continuation-in-part of application No. 10/611,037, filed on Jun. 30, 2003.
Application No. 10/708,542 is a continuation-in-part of application No. 10/188,768, filed on Jul. 2, 2002.
(60) Provisional application No. 60/314,404, filed on Aug. 23, 2001.
(60) Provisional application No. 60/428,062, filed on Nov. 21, 2002.
(60) Provisional application No. 60/428,443, filed on Nov. 22, 2002.

(51) Int. Cl. G06F 17/60

(52) U.S. Cl. 705/6; 705/5

(57) ABSTRACT

An integrated travel service broker for facilitating transactions between travel inventory suppliers and buyers is disclosed. The system comprises a network with hub sites that provide a centralized connection for travel office point of service terminals and travel vendor databases and inventories. A user may purchase travel inventory by browsing a travel service broker database and a travel history database for travel itineraries, then selecting one of the travel itineraries and placing an order for travel services. The user also browses opaque bids placed in response to the order and selects one of the bids for purchase.

### CROSS-REFERENCE TO RELATED APPLICATIONS

This application claims priority to, and is a continuation-in-part of, U.S. patent application Ser. No. 10/708,542 entitled “Travel Service Broker System” filed Mar. 10, 2004, which claims the benefit of, and priority to, U.S. patent application Ser. No. 10/217,666, entitled “Integrated Travel Industry System,” filed Aug. 12, 2002 (which itself claims the benefit of, and priority to, U.S. Provisional Application No. 60/314,404, filed Aug. 23, 2001), and U.S. patent application Ser. No. 10/611,037 entitled “System And Method For Facilitating Transactions Among Consumers And Providers Of Travel Services,” filed Jun. 30, 2003 (which itself claims the benefit of, and priority to, U.S. Provisional Patent Application No. 60/428,062, entitled “Travel Information Distribution System And Method” and filed Nov. 21, 2002, and U.S. Provisional Patent Application No. 60/428,443, entitled “Travel Information Distribution System And Method,” and filed Nov. 22, 2002; U.S. patent application Ser. No. 10/217,666, entitled “Integrated Travel Industry System,” and filed on Aug. 12, 2002, and U.S. patent application Ser. No. 10/188,768, entitled “System And Method For Airline Purchasing Program Management,” filed on Jul. 2, 2002), the entire contents of all of these applications are hereby incorporated by reference in their entirety.

### FIELD OF INVENTION

The present invention generally relates to travel service brokers, and more particularly, to a system and method that provides a single travel broker for facilitating transactions among travel inventory suppliers and travel inventory buyers.

### BACKGROUND OF INVENTION

The last half of the twentieth century, and particularly the last two decades, has been characterized by rapid changes in the travel industry. The growth of the airline business, for example, has resulted in the proliferation of travel agencies and other travel information groups that often access large volumes of data in a “real time” environment. This growth has led to many technological advancements in computer reservation systems (CRS), also known as Global Distribution Systems (GDS), for the travel industry. The terms Global Distribution System (GDS) and Computer Reservation System (CRS) will be used interchangeably herein. A GDS is a computer network that provides travel agents and other travel information groups with inventory access related to hotel, condominium, rental car, airline and the like. Examples of such inventory systems include the SABRE™, Amadeus, Galileo/Apollo, System One, and Worldspan systems. Traditionally, travel agents use a computer that connects directly to a GDS company.

Unfortunately, a direct connection between the travel offices and a GDS typically created a reliance on the GDS, thereby resulting in traveler reservations that may not have been very cost efficient. Additional problems have often arisen due to the complexity and cost related to maintaining and updating hardware and software, especially on those systems where there are multiple GDS networks and desktop standards. In addition, there is often a lack of connectivity between travel offices that utilize different GDS systems or configurations due to the private autonomous nature of GDS networks. The autonomous nature of GDS networks lead to further inefficiencies such as the inability to deliver Internet access to the travel offices through the same system. Internet access is desired, as it would allow for the integration of traveler reservations with low cost inventories such as Internet fares and/or connection with vendor direct inventory.

### SUMMARY OF INVENTION

The present invention addresses many of the shortcomings of the prior art by providing integrated, flexible systems and methods for facilitating transactions among consumers and providers of travel services. In accordance with various embodiments of the invention, so called products and “low-end” users having relatively straight-forward travel needs may be accommodated with a low-cost, right-sized set of capabilities. At the same time, various embodiments of the invention may be utilized to suit differing needs and desires of other users. As the invention facilitates the satisfaction of differing needs and desires of varying users, appropriate fees, costs, and other terms may be negotiated and/or differentiated, thereby allowing market forces to cause rational economic decisions to be made considering both the costs and benefits of the specific embodiment that is chosen and the specific circumstances in which it is to be used.

In an exemplary embodiment, a system for facilitating transactions among travel inventory suppliers and travel inventory buyers comprises an integrated travel network and a travel service broker database connected to the network, wherein the travel service broker database is configured for direct access by the travel inventory suppliers and the travel inventory buyers. The system further comprises a travel history database connected to the network, wherein the travel history database is configured to store information about the transactions and a point of service terminal connected to the network, wherein the point of service terminal is configured to access the broker database and the travel history database.

### BRIEF DESCRIPTION OF THE DRAWINGS

A more complete understanding of the present invention may be derived by referring to the detailed description when considered in connection with the Figures, where like reference numbers refer to similar elements throughout the Figures, and:

FIGS. 1A and 1B illustrate a schematic diagram of an exemplary travel service broker system in accordance with an embodiment of the invention;

FIG. 2 illustrates a schematic diagram of an exemplary travel service broker system in accordance with an embodiment of the invention;

FIG. 3 illustrates a schematic diagram of an exemplary network in accordance with an embodiment of the invention; and

FIG. 4 illustrates a schematic diagram of exemplary databases in accordance with an embodiment of the invention.

### DETAILED DESCRIPTION

In general, the invention provides for an integrated travel service broker system that includes a travel network that may be provided and managed by a single vendor that is particularly skilled in providing and servicing networks (e.g., AT&T, British Telecom). In this manner, a managed network may be monitored, in an exemplary embodiment, 24 hours a day, 7 days a week thus providing a single or reduced point of contact for outages, and further providing for real time (or substantially real time) and historical reporting. In accordance with various embodiments, the travel service broker system may be divided into multiple sub-networks, where each sub-network may be managed by a single vendor that could vary over time or according to other criteria. That is, one sub-network may be managed by AT&T and another sub-network may be managed by British Telecom and the sub-networks may be coupled together to form the travel network.

More particularly, the invention facilitates the integration between travel offices, the Internet, and suppliers of travel inventories such as, for example, airline, hotel, rental cars, and other inventories traditionally provided via a GDS. In addition, the invention facilitates integration with other travel suppliers such as, for example, alternate inventories (e.g., limousine providers), vendor direct systems, and other reservation processing technologies (e.g., document delivery, file finishing, trip planning) such that access to inventories (e.g., low cost inventories) is provided to travel inventory buyers and access to the travel service buyers is provided to the travel inventory suppliers.

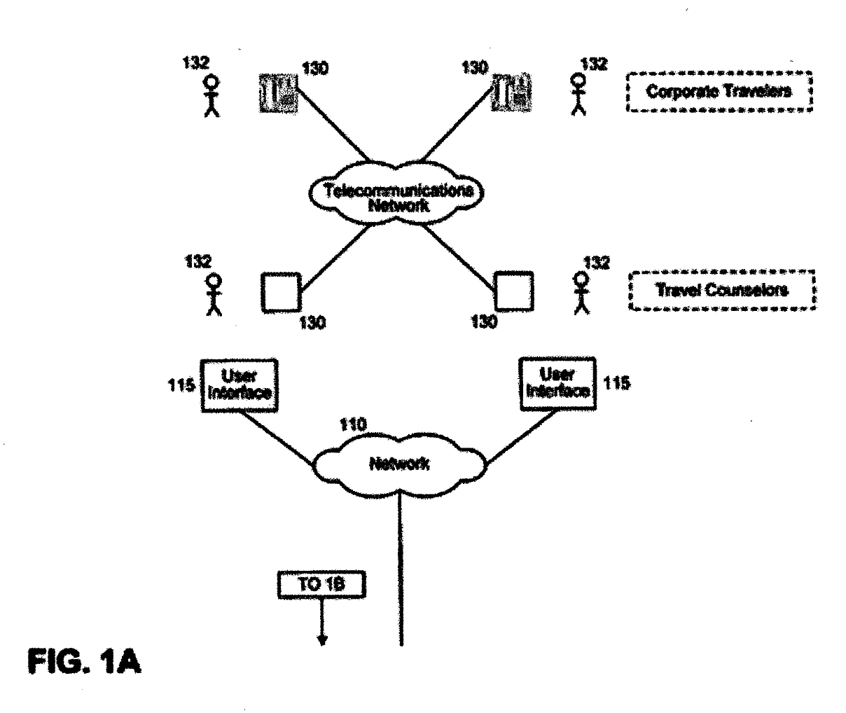

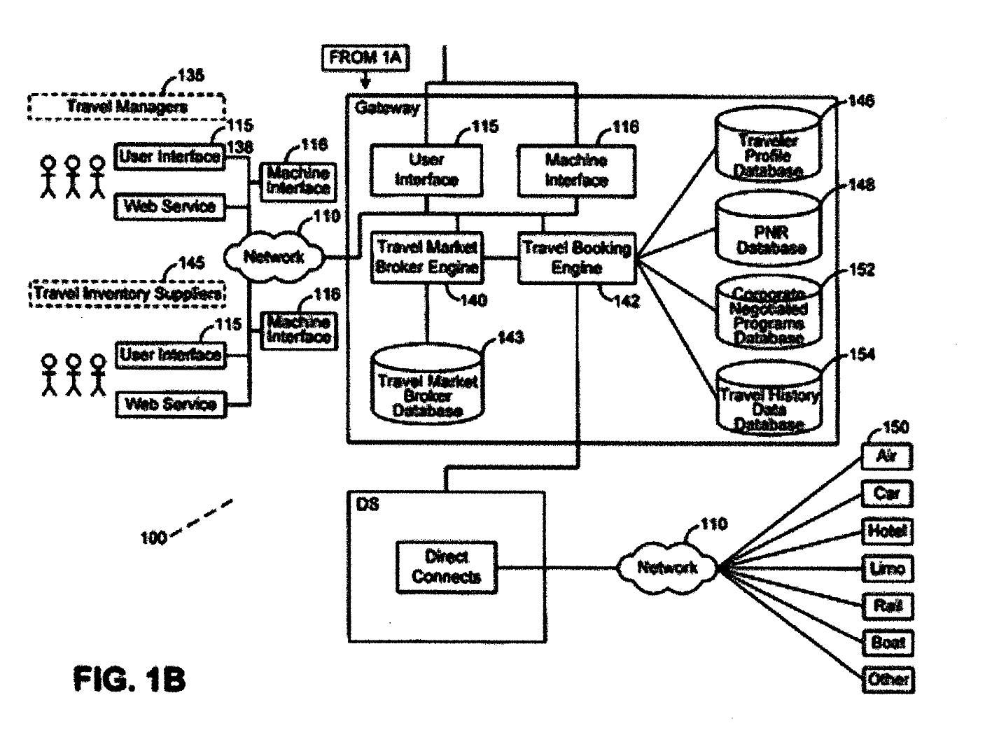

Referring to FIGS. 1A and 1B, shown is an integrated travel service broker system 100, according to an embodiment of the present invention, that directly integrates travel inventory suppliers and buyers in a manner that is independent from a particular computer system, such as a GDS system. System 100 facilitates substantial technology independence from, or limited dependence on, the GDSs, thereby achieving a network that is business driven, business responsive and enabling a company to become an industry leader. Travel inventory suppliers 145 (also known as travel service suppliers) may be any entity that sells travel services. In one embodiment, travel inventory suppliers include traditional suppliers such as name brand carriers, consolidators, and liquidators, as well as those suppliers who have purchased inventory, such as suppliers who have purchased inventory via a sponsored Travel Commodities Exchange system.

In one embodiment, system 100 includes a host server or other computing systems including a processor for processing digital data, a memory coupled to said processor for storing digital data, an input digitizer coupled to the processor for inputting digital data, an application program stored in said memory and accessible by said processor for directing processing of digital data by said processor, a display coupled to the processor and memory for displaying information derived from digital data processed by said processor and a plurality of databases, said databases including client data, travel data, supplier data, merchant data, financial institution data and/or like data that could be used in association with system 100. As those skilled in the art will appreciate, user computer will typically include an operating system (e.g., Windows NT, 95/98/2000, Linux, Solaris, Windows XP, etc.) as well as various conventional support software and drivers typically associated with computers. User computer can be in a home or business environment with access to a network. In an exemplary embodiment, access is through the Internet through a commercially-available web-browser software package.

Communication between users 132 and system 100 is accomplished through any suitable communication means (and travel network 110 may include), such as, for example, a telephone network, Intranet, Internet, point of interaction device (point of sale device, personal digital assistant, cellular phone, kiosk, etc.), online communications, off-line communications, wireless communications, and/or the like. One skilled in the art will also appreciate that, for security reasons, any databases, systems, or components of system 100 may consist of any combination of databases or components at a single location or at multiple locations, wherein each database or system includes any of various suitable security features, such as firewalls, access codes, encryption, de-encryption, compression, decompression, and/or the like.

With continued reference to FIGS. 1A and 1B, in accordance with an exemplary embodiment, travel service broker system 100 includes a travel network 110 and one or more multi-use point of service (POS) terminals 130 located at travel offices and other sites. The customer terminals may be located anywhere in the world and are connected to travel network 110 such that the users (i.e., travelers and travel counselors) of the terminals have access to various features of the system 100 as will be described in detail below. In addition, system 100 includes travel managers (i.e., travel inventory buyers) 135 and travel inventory suppliers 145.

Travel network 110 is further configured to provide access to travel booking databases 144, travel service broker database 143, and to a plurality of travel vendors 150 such as, for example, airline databases, car and hotel databases, train and bus databases, frequent flyer systems (e.g., Orbit), and the like. Access is provided through various user interfaces 115 (e.g., web browsers, rich client applications using Java), machine interfaces 116, travel market broker engine 140, and travel booking engine 142. Machine interfaces 116 include web services; synchronous/asynchronous messaging technology such as Java Message Service (JMS), MQSeries; Remote Procedure Call mechanisms; Enterprise Java Beans; direct database access such as Java database connectivity (JDBC), open database connectivity (ODBC), structured query language (SQL) statements; and other programmatic mechanisms. Travel market broker engine 140 and travel booking engine 142 are configured to facilitate accessing and updating travel booking databases 144 in order to provide information to travel managers 135, travel inventory suppliers 145, and other users such as travelers and travel counselors. In addition, travel market broker engine 140 and travel booking engine 142 are configured to facilitate updating travel booking databases 144 in order to reflect changes to the database information.

In accordance with one embodiment, travel booking databases 144 include traveler profile database 146, passenger name record (PNR) Database 148, corporate negotiated programs database 152, and travel history data warehouse 154. In accordance with one embodiment, traveler profile database 146 contains traveler preferences data that was initially provided by the traveler and/or the traveler's employer and is periodically updated by the traveler and/or the traveler's employer. PNR database 148 contains traveler itinerary data that is dynamically created and/or updated whenever a traveler makes or updates travel plans. Corporate negotiated programs database 152 contains travel contract data that is regularly updated. Travel history data warehouse 154 contains historical travel data that is regularly updated. In accordance with one embodiment, travel market broker database 143 contains travel inventory data that is created and regularly updated by travel inventory suppliers or other entities that maintain system 100.

Network 110 enables a substantially open and substantially consistent vehicle for non-GDS communication such as e-mail, Internet and the like, which is, inter alia, less expensive and less complex than having to provide a separate network for non-GDS communications. It should be appreciated that providing access to the Internet will give e-mail access to POS terminal users of travel industry system 100. Specific information related to the protocols, standards, and application software utilized in connection with the Internet may not be discussed herein. For further information regarding such details, see, for example, Dilip Naik, Internet Standards and Protocols (1998); Java 2 Complete, various authors, (Sybex 1999); Deborah Ray and Eric Ray, Mastering HTML 4.0 (1997). Loshin, TCP/IP Clearly Explained (1997). All of these texts are hereby incorporated by reference.

Travel vendor databases 150 may include databases for travel related services such as, for example, airlines, car rental, hotel, train, bus, limousines, and any other travel related service. As used in system 100, a database may be any type of database, such as relational, hierarchical, object-oriented, and/or the like. Common database products that may be used to implement the databases include DB2 by IBM (White Plains, N.Y.), any of the database products available from Oracle Corporation (Redwood Shores, Calif.), Microsoft Access by Microsoft Corporation (Redmond, Wash.), or any other database product. Database may be organized in any suitable manner, including as data tables or lookup tables. Association of certain data may be accomplished through any data association technique known and practiced in the art. For example, the association may be accomplished either manually or automatically. Automatic association techniques may include, for example, a database search, a database merge, GREP, AGREP, SQL, and/or the like. The association step may be accomplished by a database merge function, for example, using a “key field” in each of the manufacturer and retailer data tables. A “key field” partitions the database according to the high-level class of objects defined by the key field. For example, a certain class may be designated as a key field in both the first data table and the second data table, and the two data tables may then be merged on the basis of the class data in the key field. In this embodiment, the data corresponding to the key field in each of the merged data tables is preferably the same. However, data tables having similar, though not identical, data in the key fields may also be merged by using AGREP, for example.

In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); block of binary (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one exemplary embodiment, the ability to store a wide variety of information in different formats is facilitated by storing the information as a Binary Large Object (BLOB). Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the financial transaction instrument by multiple and unrelated owners of the data sets. For example, a first data set which may be stored may be provided by a first issuer, a second data set which may be stored may be provided by an unrelated second issuer, and yet a third data set which may be stored, may be provided by an third issuer unrelated to the first and second issuer. Each of these three exemplary data sets may contain different information that is stored using different data storage formats and/or techniques. Further, each data set may contain subsets of data which also may be distinct from other subsets.

As stated above, in various embodiments, the data can be stored without regard to a common format. However, in one exemplary embodiment, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified merchants are permitted to access the data set for reading, and others are altogether excluded from accessing the data set. However, other access restriction parameters may also be used allowing various entities to access a data set with various permission levels as appropriate.

The data, including the header or trailer may be received by a stand alone interaction device configured to add, delete, modify, or augment the data in accordance with the header or trailer. As such, in one embodiment, the header or trailer is not stored on the transaction device along with the associated issuer-owned data but instead the appropriate action may be taken by providing to the transaction instrument user at the stand alone device, the appropriate option for the action to be taken. System 100 may contemplate a data storage arrangement wherein the header or trailer, or header or trailer history, of the data is stored on the transaction instrument in relation to the appropriate data.

With continued reference to FIGS. 1A and 1B, users 132, travel managers 135, and travel inventory suppliers 145 may be in direct communication to network 110, such that the external customers have direct access to the travel network. In this manner, users 130, travel managers 135, and travel inventory suppliers 145 may access various features of the system as described below.

In accordance with one embodiment, travel service broker system 100 may provide a suitable website or other Internet-based graphical user interface which is accessible by users 130, travel managers 135, and travel inventory suppliers 145 and other users of the system. Travel inventory suppliers 145 may qualify and register for participation in travel service broker system 100. In addition, travel inventory suppliers 145 may terminate participation in the system. In one embodiment, the Internet Information Server, Microsoft Transaction Server, and Microsoft SQL Server, are used in conjunction with the Microsoft operating system, Microsoft NT web server software, a Microsoft SQL database system, and a Microsoft Commerce Server. Additionally, components such as Access Sequel Server, Oracle, MySQL, Intervase, etc., may be used to provide an ADO-compliant database management system. The term “webpage” as it is used herein is not meant to limit the type of documents and applications that might be used to interact with the user. For example, a typical website might include, in addition to standard HTML documents, various forms, Java applets, Javascript, active server pages (ASP), common gateway interface scripts (CGI), extensible markup language (XML), dynamic HTML, cascading style sheets (CSS), helper applications, plug-ins, and the like.

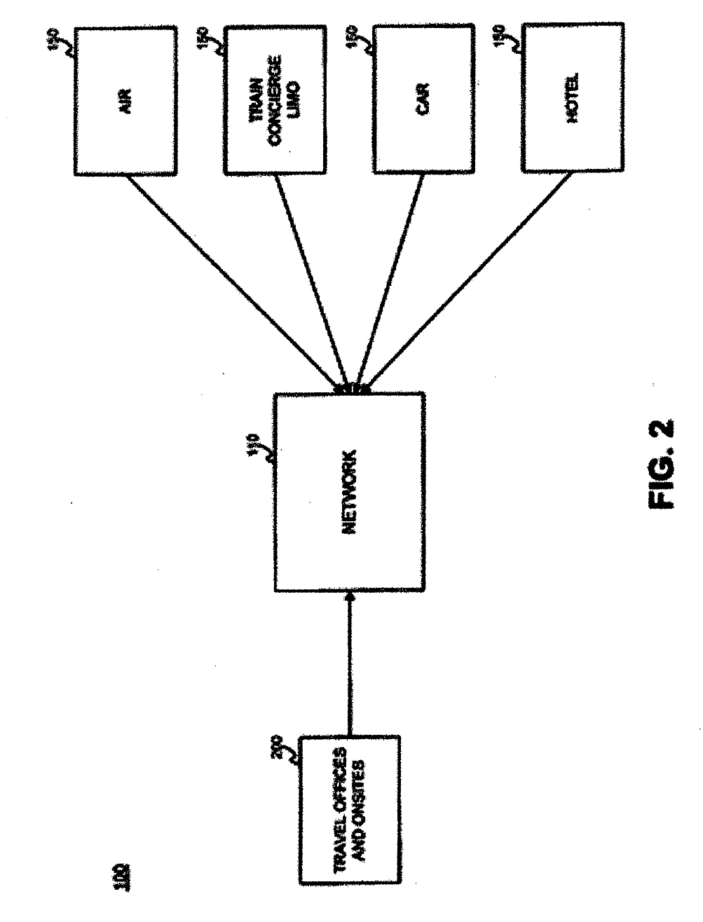

With reference to FIG. 2, in an exemplary embodiment, various components of travel industry system 100 communicate with network 110 such that a centralized connection to network 110 is obtained. For example, travel vendors 150, and multi-use terminals 130 at travel offices 200 and other sites may be centrally connected to network 110 such that users of the multi-use terminals have access to various components of system 100 such as travel vendor databases 150.

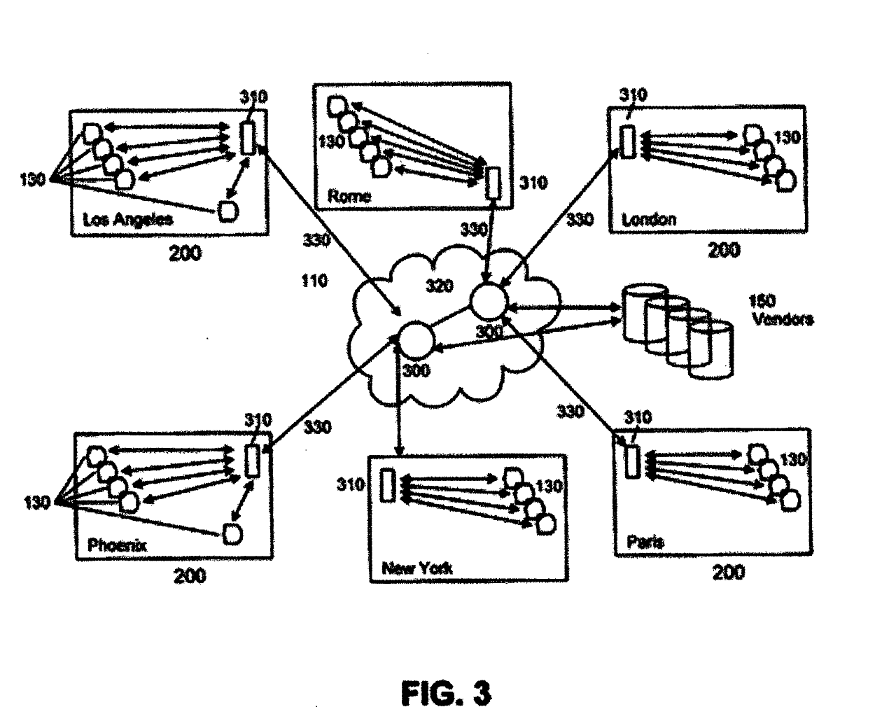

Referring now to FIG. 3, travel service broker system 110, in an exemplary embodiment, comprises a frame relay network having one or more hub sites 300 that are used to connect travel offices 310 and other users from around the world. As is well known in the art, frame relay networks are a type of network that is used to transport data from location to location using connections, such as network components 310, which may comprise a router or equivalent network device. For example, as illustrated in FIG. 3, there may be travel offices 310 in New York, Phoenix, Los Angeles, Rome, London, and Paris. Travel network 110 provides an integrated network such that any travel office in any city can communicate with any other travel office in any city which will allow for more efficient communication and distribution of information. For example, memos and other information can now be distributed electronically utilizing travel network 110, thus saving time and money compared to previous systems where a travel office could not communicate electronically with another travel office that was utilizing a different GDS system. It will be appreciated that these locations 300 are for exemplary purposes only, and that the present invention is not limited to these locations.

Travel network 110 may use an Asynchronous Transfer Mode (ATM) backbone and multiple redundant data centers. For example, as illustrated in FIG. 3, network 110 may include two hub sites 300 that provide for data redundancy as will be described. Alternatively, network 110 may comprise one hub site or network 110 may comprise more than two hub sites. Data and connectivity redundancy is provided for, in one embodiment, when there are two or more hub sites 300. Alternatively, travel network 110 may comprise any other suitable network that provides similar functionality to a frame relay network. Hub sites 300 may be connected to each other by network connection 320. In accordance with one embodiment, network connection 320 may comprise an ATM backbone. Alternatively, network connection 320 may comprise a different type of network connection such as a T1 connection.

In an exemplary embodiment, travel vendor databases 150 may be connected to network 110 at each of the hub sites 300, thus providing redundant connectivity points for the travel vendors. By centralizing the connection to travel vendors 150, system 100 facilitates allowing a company to negotiate directly with air, car rental, hotel vendors, and the like, based on direct connections and fulfillment options, wherein connection is not limited only through GDS hosts. Direct connections to various vendor databases (e.g., air, car rental, hotel, rail, limousines, cruise lines, conference centers, ferries) make it possible for travelers to have a broader range of travel service choices. In this manner, access is provided to various low cost carriers including web fares, discounters and consolidators. System 100 also allows alternative supply and distribution channels for products and services which may be provided by plugging a vendor directly into network 110.

System 100 provides for a central connection to all vendors. In an exemplary embodiment, the system includes no GDS-supplied hardware and allows a company to respond to technology or product improvements with no GDS approval thus providing for a host independent of individual GDSs.

In addition, if a new travel office is to be deployed, the travel office needs only to be connected to network 110 as will be described below. This allows for a short time to market for a new travel office. More particularly, each travel office may have one or more customer terminals 130 that provide user access to the system 100 through network component 310. In accordance with one embodiment, network components 310 are connected to hub sites 300 by network connections 330. Network connection 300 may be any type of suitable network connection such as T1, ATM, ISDN, and the like. Customer terminals 130 may have access to the various travel vendor databases through hub sites 300. The multi-use terminals 130 may be used to provide a single source for accessing multiple travel vendor databases for users (e.g., travel counselors). These multi-use terminals provide travel counselors with a new user-friendly, browser based Point of Service tool (a.k.a. Customer Information Gateway) that can be used for servicing customers as described in detail below. Travel counselors only need to be trained on a single computer user interface/software application in order to be able to access a plurality of travel vendor databases. Stated another way, multi-use terminal 130 may be operated the same or similar way, no matter which travel vendor database or inventory is accessed. In this manner, the customer terminals 130 of the system provide for a user-friendly operation (travel counselors may need no GDS format skills) and a customer focused reservation process with none of the restrictions that are traditionally applied by GDS's. It will be appreciated that that the standard user interface provided by the system is easy to use, provides uniform access to all databases, and reduces the amount of travel business expertise required to use it. In accordance with one embodiment, user interfaces 115 include browser-based applications that access web pages or execute Java applets ActiveX controls; standalone application programs known as rich clients written in Java, NET, C/C++, and the like.

If one of the hub sites is disabled, customer terminal 130 may be automatically connected to another hub site 300 that is active via network connections 330 and 320, thus providing continuous network connection for the travel office and their customer terminals.

As will be described in detail, system 100 provides a method to obtain, manage, buy, sell, and broker virtually any kind of traditional and non-traditional travel inventory. In addition, system 100 provides a managed-travel arrangement service to business travelers that are users of travel inventory. System 100 also provides for all customer data and transaction details to remain private unlike current travel systems that store their travel data in the GDS systems and become owned by those systems. System 100 provides business travelers a one-stop shopping place for all their travel needs with access to a wide variety of travel inventory. Business travel managers can maintain a complete view of all their travel usage, thus, eliminating the need for corporate clients to contract with multiple travel service providers in order to be able satisfy all their travel needs.

Typical use of the Travel Market Broker system would be as follows. Corporate clients, other travelers, and travel inventory suppliers would register to use the Travel Market Broker system. Travelers would book travel through the system. Travel service managers for a corporation would use the Traveler History Data Warehouse function of the Travel Market Broker system to determine their travelers' currently booked travel itineraries and to determine their travelers' historical travel itineraries. Based on those plans, the travel service manager may attempt to reduce the associated travel costs (or to better perform on their negotiated travel programs) by using the reverse auction function to query previously posted inventory or to place an order for some or all those travel itineraries. The order would consist of details such as date and time range of travel, geographic location, quantity, price range, required minimum difference between price and the corporate negotiated price (to offset any penalties from deviating from the negotiated program). Registered travel inventory suppliers would either post inventory for browsing or return a bid in response to the order. Travel service manager would select the best bid and use the system to modify the affected travel itineraries to take advantage of the bid results.

Alternately, the travel service manager may use the Traveler History Data Warehouse function of the Travel Market Broker system to determine their travelers' past travel patterns. The results could be used to create MIS reports or to understand recurring travel needs and in turn use the reverse auction function to procure travel inventory at optimal cost to satisfy those future travel needs. The procured inventory would be consumed by a future travel arrangement made through the managed-travel arrangement service. Regarding the travel inventory procured via the reverse auction function, the Travel Market Broker system might not actually buy the inventory but may instead simply make the inventory available to the buyer per the terms set by the seller. As a premium service for advanced users, a fully-featured speculative travel-futures trading function could be made available. All inventory could be consumed by the managed-travel arrangement service.

Groups of smaller buyers could band together to form co-ops to increase their buying power through the reverse auction by pooling their buying orders. Similarly, groups of sellers could form co-ops to bid on orders.

Travel inventory suppliers 145 may be any entity that has a legal right to sell travel services. This would include the traditional suppliers such as name brand carriers, consolidators, and liquidators as well as those suppliers who have purchased inventory via an American Express sponsored Travel Commodities Exchange system.

It will be appreciated that many applications could be formulated. One skilled in the art will appreciate that network 110 may interface with any system for exchanging data or transacting business, such as the Internet, an intranet, an extranet, WAN, LAN, satellite communications, and/or the like. The users may interact with the system via any input device such as a keyboard, mouse, kiosk, personal digital assistant, handheld computer (e.g., Palm Pilot®), cellular phone and/or the like. Similarly, system 100 could be used in conjunction with any type of personal computer, network computer, workstation, minicomputer, mainframe, or the like running any operating system such as any version of Windows, Windows NT, Windows2000, Windows 98, Windows 95, MacOS, OS/2, BeOS, Linux, UNIX, Solaris, Windows XP, or the like. Moreover, although system 100 is frequently described herein as being implemented with TCP/IP communications protocols, it will be readily understood that system 100 could also be implemented using IPX, Appletalk, IP-6, NetBIOS, OSI or any number of existing or future protocols. Moreover, the system contemplates the use, sale or distribution of any goods, services or information over any network having similar functionality described herein.

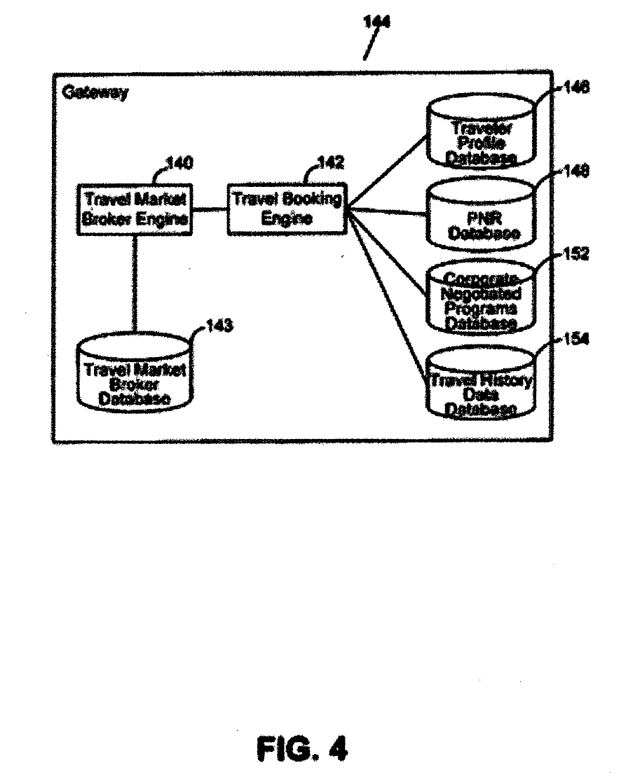

Referring now to FIG. 4, databases 144 provide substantially private, secure, and confidential storage of all travel data including traveler data, corporate client data, and the Market Information Data Tape (MIDT). Databases 144 include traveler market broker database 143, traveler profile database 146, PNR database 148, corporate negotiated programs database 152, and travel history data warehouse 154. Travel inventory suppliers 145 may post and edit inventory in the travel service broker database 143. The posted inventory may include information concerning dates and time, geographic location, quantity, price ranges, amenities, restrictions and other relevant information. The inventory may be viewed by travel service buyers 135 who may browse and perform queries on the inventory using a user interface 138.

Travel service buyers 135 may access traveler history data warehouse 154 to obtain historical travel information in order to predict traveler's future travel plans such as volume of travel, destinations, dates, times, carriers, cost, and other travel itinerary details. Travel service buyers 135 may use this information to place orders to suppliers in order to reduce travel cost and get better deals. The orders may include details such as date and time range of travel, geographic location, quantity, price range, required minimum difference between price and the corporate negotiated price, desired amenities, and other trip requirements. Travel inventory suppliers 145 may then place bids for the orders in a reverse auction fashion. The travel inventory suppliers' bids may be “opaque” such that competitors and current customers cannot see the bid. This will allow suppliers to discretely unload inventory at lower prices than available through their retail channels and without drawing attention from competitors or current customers. The suppliers may not be able to view the responses of their competitors. The travel inventory suppliers may configure alerts for types of orders that are desired to be acted upon. In addition, a matching function may be provided that determines which previously posted inventory or returned bids satisfy a placed order and returns the results to the travel service buyer for final selection and approval.

In addition, travel inventory suppliers may form a cooperative or otherwise pool travel service orders within their corporation in order to seek volume discounts from suppliers. MIS reports may be obtained from the traveler history data warehouse 154 that detail past traveler travel history per corporate client such as city-pairs, date and time of travel, suppliers used, length of stay, trend analysis and the like. Travel inventory buyers and sellers could sign-up for one of several tiers of a premium MIS reporting service that allows either real-time (on-line), near real-time (on-line but delayed in order to not bog down the system, alert sent when report is available), or batch (done off-peak—daily, weekly, monthly, yearly—alert sent when report is available or user polls system for the report status). Premium services could provide access to a reporting tool that would allow the customization of queries and format while the base service provides only canned reports. The reports help shape the buying habits of buyers and the selling habits of sellers. The reports also indicate how well buyers and sellers met their performance goals. This information could be sold to the travel customer to assist with negotiating discount rates with their frequently used travel inventory suppliers. Additional MIS reports may be obtained from the travel market broker database 143 that detail the activity for a travel inventory supplier's account.

System 100 and the related methods may be described herein in terms of functional block components, screen shots, optional selections and various processing steps. It should be appreciated that such functional blocks may be realized by any number of hardware and/or software components configured to perform the specified functions. For example, system 100 may employ various integrated circuit components, e.g., memory elements, processing elements, logic elements, look-up tables, and the like, which may carry out a variety of functions under the control of one or more microprocessors or other control devices. Similarly, the software elements of system 100 and method may be implemented with any programming or scripting language such as C, C++, Java, COBOL, assembler, PERL, extensible markup language (XML), and Microsoft's Visual Studio NET, with the various algorithms being implemented with any combination of data structures, objects, processes, routines or other programming elements. Further, it should be noted that the system 100 and methods might employ any number of conventional techniques for data transmission, signaling, data processing, network control, and the like. For a basic introduction of cryptography and network security, the following may be helpful references: (1) “Applied Cryptography: Protocols, Algorithms, And Source Code In C,” by Bruce Schneier, published by John Wiley & Sons (second edition, 1996); (2) “Java Cryptography” by Jonathan Knudson, published by O'Reilly & Associates (1998); (3) “Cryptography & Network Security: Principles & Practice” by William Stalling, published by Prentice Hall; all of which are hereby incorporated by reference.

It should be appreciated that the particular implementations shown and described herein are illustrative of the invention and its best mode and are not intended to otherwise limit the scope of the present invention in any way. Indeed, for the sake of brevity, conventional data networking, application development and other functional embodiments of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical electronic transaction system.

As will be appreciated by one of ordinary skill in the art, the present invention may be embodied as a method, a data processing system, a device for data processing, and/or a computer program product. Accordingly, the present invention may take the form of an entirely software embodiment, an entirely hardware embodiment, or an embodiment combining embodiments of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The present invention is described herein with reference to screen shots, block diagrams and flowchart illustrations of methods, apparatus (e.g., systems), and computer program products according to various embodiments of the invention. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

In the foregoing specification, the invention has been described with reference to specific embodiments. However, it will be appreciated that various modifications and changes can be made without departing from the scope of the present invention. The specification and figures are to be regarded in an illustrative manner, rather than a restrictive one, and all such modifications are intended to be included within the scope of present invention. For example, the steps recited in any of the method or process claims may be executed in any order and are not limited to the order presented.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical”.

1. A travel service broker system for facilitating transactions among travel inventory suppliers and travel inventory buyers, the system comprising:
an integrated travel network;
a travel service broker database connected to the network, wherein the travel service broker database is configured for direct access by the travel inventory suppliers and the travel inventory buyers;
a travel history database connected to the network, wherein the travel history database is configured to store information about the transactions; and
a point of service terminal connected to the network, wherein the point of service terminal is configured to access the travel service broker database and the travel history database.

2. The travel service broker system of claim 1, further comprising a plurality of travel booking databases.

3. The travel service broker system of claim 2, wherein the plurality of travel booking databases comprise at least one of a traveler profile database, a passenger name record database, and a corporate negotiated programs database.

4. The travel service broker system of claim 1, further comprising a plurality of travel booking databases having a traveler profile database, wherein the traveler profile database comprises traveler preference data.

5. The travel service broker system of claim 1, further comprising a plurality of travel booking databases having a passenger name record database, wherein the passenger name record database comprises traveler itinerary data.

6. The travel service broker system of claim 3, further comprising a plurality of travel booking databases having a corporate negotiated programs database, wherein the corporate negotiated programs database comprises travel contract data.

7. The travel service broker system of claim 1, wherein the travel inventory suppliers comprise at least one of name brand carriers, consolidators, liquidators, and inventory purchasers.

8. The travel service broker system of claim 1, wherein the travel inventory buyers comprise corporate travel managers.

9. The travel service broker system of claim 1, wherein the point of service terminal is located at a site remote from the travel service broker database and the travel history database.

10. The travel service broker system of claim 9, wherein the remote site comprises a travel office.

11. The travel service broker system of claim 1 further comprising a plurality of travel vendors connected to the network.

12. The travel service broker system of claim 11, wherein the plurality of travel vendors comprise at least one of airline databases, car and hotel databases, train and bus databases, and frequent flyer systems.

13. The travel service broker system of claim 1, further comprising a plurality of user interfaces and a plurality of machine interfaces, wherein the user interfaces and the machine interfaces facilitate access to the travel service broker system for the travel inventory buyers and the travel inventory suppliers.

14. A method for purchasing travel inventory comprising:
browsing a travel service broker database and a travel history database for travel itineraries;
selecting one of the travel itineraries;
placing an order for travel services, wherein the order is based on the selected travel itinerary;
browsing a plurality of opaque bids placed in response to the order; and
selecting one of the plurality of bids for purchase.

15. The method of claim 14, further comprising registering to use a travel service broker system.

16. The method of claim 14, further comprising the step of modifying the selected travel itinerary based upon the purchased bid.
